(19) United States
(12) Patent Application Publication
(10) Pub. No.: US 2013/0056936 A1
(43) Pub. Date: Mar. 7, 2013

(54) METHOD AND DEVICE FOR PRODUCING SEALING RINGS

(71) Applicants: Rolf Prehn, Wipperfurth (DE); Axel Ulbrich, Kausen (DE)

(72) Inventors: Rolf Prehn, Wipperfurth (DE); Axel Ulbrich, Kausen (DE)

(21) Appl. No.: 13/697,426

(22) PCT Filed: Jan. 26, 2011
(86) PCT No.: PCT/EP2011/051041

§ 371 Date: Nov. 12, 2012

(30) Foreign Application Priority Data
May 10, 2010 (DE) 102010028797.0

(51) Int. Cl. B21H 1/06; F02F 11/00

(52) U.S. Cl. 277/345; 29/412; 29/557; 29/650

(57) ABSTRACT

The invention relates to a method for producing sealing rings open to the outside or to the inside, which method comprises the steps of providing a tube, arranging the wall of the tube between at least one first roller that is parallel to the tube and has a first outside contour, and at least one second roller that is parallel to the tube and has a second outside contour; carrying out a relative movement of the at least one first roller and the at least one second roller towards each other; forming at least one sealing ring by a relative movement of the wall of the tube between the at least one first roller and the at least one second roller, wherein the cross-section of the at least one sealing ring is defined substantially by the space between the first and second outside contours; and severing the at least one sealing ring from the tube. The invention also relates to a device for carrying out the method and to a selling ring produced in said manner.

The invention relates to a method for producing sealing rings open to the outside or to the inside, and to a device for carrying out the method. In particular, the invention relates to the production of C- or V-shaped sealing rings, for example, for turbochargers of internal combustion engines.

It is known to produce such sealing rings by punching them out of sheet metal. However, for process-related reasons, this results in a large portion of waste material. Since the material used involves primarily high-quality and thus expensive materials such as, for example, Inconel®, this is a significant cost factor. Furthermore, for this kind of production of sealing rings open to the inside, a work aid such as, for example, rubber is required which makes this forming process possible. This work aid is subject to serious wear, and handling the work aid significantly influences the duration of the production process.

It is therefore an object of the present invention to propose a new production method and a device suitable for this method so as to solve the aforementioned problems. In particular, a reduction of the production waste and an increase of the processing speed shall be achieved therewith.

According to a first aspect of the invention, a method for producing sealing rings open to the outside or to the inside is proposed, the method comprising the steps of
providing a tube;
arranging the wall of the tube between at least one first roller that is parallel to the tube and has a first outer contour, and at least one second roller that is parallel to the tube and has a second outer contour;
carrying out a relative movement of the at least one first roller and the at least one second roller toward each other;
forming at least one sealing ring by a relative movement of the wall of the tube between the at least one first roller and the at least one second roller, wherein the cross-section of the at least one sealing ring is defined substantially by the space between the first and the second outer contours; and
severing the at least one sealing ring from the tube.

With the contouring-severing production method according to the invention, the amount of waste material is considerably reduced and the processing speed is increased. Metallic materials such as aluminum, spring steels, heat-resistant materials (1.4828), nickel-base alloys (2.4668) and also non-metallic materials or combinations thereof can be used as materials for the tube.

According to the invention, the tube can also have a partial or complete coating. Said tube is preferably circular cylindrical.

In one embodiment, the at least one first roller rotates at least during forming in a first direction of rotation.

In one embodiment, the at least one second roller rotates at least during forming in a second direction of rotation.

In one embodiment, the tube rotates at least during forming in the first direction of rotation.

The aforementioned embodiments with regard to the rotation of the first roller, second roller and the tube can be combined as desired. It is important here that the tube or its wall is moved in a relative movement between the contouring roller and the forming roller. The first and the second rotational directions are opposed, wherein the rotational speed can be the same or different.

A first variant includes to rotatably mount the tube in a freewheeling manner, whereas the first and/or the second roller are/is rotated. In this variant, the tube is carried along by the at least one driven roller by means of friction, thus, rotates opposite to the at least one driven (for example, first) roller and, if necessary, in the same direction as the at least one further (for example, second) roller. The at least one further roller is also carried along through friction; however, as an alternative, it can also be rotated in the respective rotational direction. In a second variant, the tube is fixed, whereas the contouring roller as well as the forming roller are driven in the respective direction of rotation and therefore rotate (in opposite directions) around the stationary tube.

The rotational speeds of first/second roller and tube can be set in such a manner that no or, alternatively, a minor friction occurs between at least one roller and the tube wall. For example, the roller can be driven (or, if necessary, decelerated) in such a manner that a speed difference occurs between tube wall and outer roller contour. This can be desired so as to achieve a grinding effect.

In one embodiment, a plurality of sealing rings is produced at the same time. In this embodiment, the contours for a plurality of sealing rings are provided on each of the first and the second rollers so that a plurality of sealing rings can be produced in a single work step.

In an alternative embodiment, in each case one sealing ring after the other is produced. In this embodiment, the contours for only one sealing ring can be provided on each of the first and second rollers so that in each case one sealing ring per work step can be produced.

In one embodiment, severing takes place during forming. It is preferred that severing is not carried out in a separate work step, for example, by cutting off, but through the forming process itself. Here, the tube material is overstressed at the small radii of the outer contour of a roller in such a manner that the material failure results in severing the sealing ring from the remaining tube or the adjacent sealing rings. By saving an additional cutting step, the production can be simplified and accelerated.

In one embodiment, forming comprises an initial preforming and a final finish forming, and severing takes place between preforming and finish forming. It is preferred that an initial forming is carried out by exclusively deforming the tube portion that is to be formed into the sealing ring. Subsequently, the tube portion is overstressed in a controlled manner by continuously deforming the edge portions of the sealing ring to be formed so that the sealing ring or the sealing rings is or are severed from the remaining tube. Deforming is then continued with the separated sealing rings(s) until the desired final shape is reached which corresponds substantially to the remaining space between the contour of the contouring roller and the contour of the forming roller.

By severing during the forming process and through the forming process itself, a relatively wide window is provided during which the severing process can be carried out. In this manner, the tubular primary products used can be handled more flexible because the severing process is carried out reliably as long as the material properties within the severing window allow severing. It is not important whether the actual severing takes place closer to the beginning of the foaming process or closer to the end of the forming process.

In one embodiment, severing takes place prior to or after forming. In this alternative embodiment, severing can also be carried out outside of the forming process. If due to the material properties of the tube, reliable severing through the forming process alone cannot be achieved, this can be offset by subsequent severing. Severing prior to the forming process enables producing one or a plurality of sealing rings in single-ring production.

In one embodiment, the method further comprises the steps of
at least cutting the wall of the tube with a cutting roll that is parallel to the at least one first roller;

wherein by said cutting, the positions are determined at which severing the at least one sealing ring is to be carried out, or at which the at least one sealing ring is severed by completely cutting it off.

If for the tubular preliminary product a material is used which due to high elasticity does not permit reliable severing through the forming process, this can be offset by this embodiment. By cutting prior to the forming process, a defined pre-existing damage to the tube is achieved at those positions at which severing during the forming process is intended. During the forming process, the previously damaged region will crack or break so that the separation is ensured.

As an alternative and independent of the forming process, i.e., prior to or after the forming process, a complete cutting-off is possible in order to achieve severing.

In one embodiment, the wall thickness of the at least one sealing ring
is increased or reduced at predeterminable positions; or
is maintained substantially homogenous

during foaming.

In one embodiment, the method includes axially compressing the tube. This is preferably ensured by movable flanges on both outer ends of the tube (movement in the axial direction of the tube). In that the movement toward each other is superimposed by a compressing movement, the tube is “unfolded” and pressed into the intermediate spaces of the forming and contouring rollers. Thereby it is achieved that the forming process is not implemented by plastic deformation of the tube, but that material is continuously fed. This effects that the wall thickness of the tube is maintained constant (or homogenous) to the greatest possible extent. Alternatively, it is also conceivable to achieve the compressing movement through an additional superimposed process such as, for example, internal or external high pressure forming using a liquid medium or a highly elastic or flowing medium such as rubber.

According to this embodiment, a portion of the tube or a section of the tube is adequately sealed—prior to the severing of sealing rings—and is pressed with the pressurized forming medium into the contours of the contouring and forming rollers, wherein the contour shape corresponds at least to an intermediate shape of the sealing ring to be formed. Pressure can be applied from the inside as well as from the outside, wherein the formed tube then deflects to the outside or the inside. As a result of this, an axial shortening or compression occurs. The advantage here is that the wall thickness of the tube remains substantially the same.

In one embodiment, forming the at least one sealing ring is carried out in at least two successive steps, wherein per step at least one first roller and at least one second roller are involved in the forming process, and the outer contour of at least one involved roller is specific for the respective step.

This production variant (in particular in the case of small sealing rings) can divide the forming process into a plurality of steps. Here, the tube is not fed to only one pair of rollers but, for example, is fed successively to a plurality of such pairs of rollers and is suitably transferred between these stations or steps. In this manner, the forming process can be better adapted to the forming capacity and ductility of the material so that the material does not break or fail at undesirable places.

In one embodiment, the method further comprises heating the tube at defined places. Heating can preferably be carried out by means of induction and/or laser.

Local or overlapping heating can be carried so as to facilitate the forming and/or severing process. Analogous to cutting the tube for defining the places at which finished sealing rings are to be severed, defined heating and therefore weakening the material can be carried out.

This can go so far that the tube is locally heated up—annularly around the tube—to such an extent that with a very low cutting force or just through a relative movement between the remaining tube and the sealing ring or between a plurality of sealing rings, said sealing rings can be severed from each other. Such a shearing results in a characteristic shearing edge which is visible on the finished sealing ring.

Complete cutting off analogous to cutting with a cutting roll can also be carried out, e.g., by means of a laser.

According to a second aspect of the invention, a device for producing sealing rings open to the outside or to the inside is provided, said device comprising
at least one first roller having a first outer contour;
at least one second roller (6) that is parallel to the first roller and has a second outer contour;
a feeding mechanism adapted for arranging the wall of a tube between the at least one first roller and the at least second roller;
at least one drive mechanism that is adapted for rotating about the tube and/or about the at least one first roller in a first direction of rotation, and/or for rotating the at least one second roller in a second direction of rotation;
a movement mechanism that is adapted for carrying out a relative movement of the at least one first roller and the at least one second roller toward each other so as to form at least one sealing ring by a relative movement of the wall of the tube between the at least one first roller and the at least one second roller, wherein the cross-section of the at least one sealing ring is defined substantially by the space between the first and the second outer contours; and
a severing mechanism that is adapted for severing the at least one sealing ring from the tube.

In one embodiment of the invention, the feeding mechanism can be one piece, i.e., it can carry out the transport of the tubular preliminary product and also the holding work during the forming process. Alternatively, the feeding mechanism can be divided into a pure transport mechanism and a separate holding device, for example, a counter bearing.

In one embodiment, the device further comprises a handling mechanism for removing finished sealing rings.

In one embodiment, the device comprises a drive mechanism that is adapted for rotating the first roller in a first direction of rotation. In a further embodiment, the device comprises a drive mechanism that is adapted for rotating the second roller in a second direction of rotation. In a further embodiment, the device comprises a drive mechanism that is adapted for rotating the tube in a first direction of rotation. The drive mechanisms can be combined as required or can be built together. For example, a drive mechanism for tube and first roller can be built as an integral part.

The drive mechanism(s) can comprise adequate gear units. For example, a drive unit could be provided for first roller, second roller and tube, wherein the directions of rotation and speeds are set through suitable gearings.

In one embodiment, the outer contours of the at least one first roller and the at least one second roller correspond to a plurality of sealing rings, and the device is adapted for producing a plurality of sealing rings at the same time. Alternatively, the device is designed for single-ring production so that the first and second rollers may have only the outer contour corresponding to an individual sealing ring.

In one embodiment, the device further comprises
at least one cutting roll that is parallel to the at least one first roller;
a second movement mechanism that is adapted for carrying out a relative movement between the at least one cutting roll and the at least one first roller toward each other so as to cut the wall of the tube by means of the cutting roll so that the places are determined at which severing the at least one sealing ring is to be carried out, or for completely cutting off the wall of the tube so that the at least one sealing ring is severed.

In one embodiment, the outer contour of the first roller and/or the second roller are adapted for reducing or thickening the wall thickness of the at least one sealing ring at predetermined places during forming the at least one sealing ring, for example, for reducing the wall thickness toward the sealing surfaces.

The advantage of this embodiment is that the contour of the later sealing ring can be significantly influenced by the forming process. This means, it is possible to roll out the ends thinner (resulting in a larger sealing line in the pressed and assembled state because the ends are bending), to maintain the material thickness substantially constant, or even to “shift” material from the middle toward the ends (as a result of which any contact geometries can be generated in the pressed and assembled state). Furthermore, through shaping, the stiffness can be considerably influenced and therefore also the spring force or the sealing force, or also the fatigue behavior. In addition, the creep or relaxation behavior can also be influenced in this manner.

Alternatively, the outer contour of the contouring roller and the forming roller are adapted to keep the wall thickness of the at least one sealing ring substantially homogenous when forming the at least one sealing ring.

In one embodiment, the device comprises a compressing mechanism that is adapted for compressing the tube in the axial direction. In addition, the compressing mechanism can comprise, for example, an internal or external high-pressure forming mechanism such as, for example, a hydroforming mechanism. Moreover, the compressing mechanism comprises seals for sealing a portion of the tube or a tube section, and if necessary, in addition an inner or outer contour shape against which the tube can rest and which corresponds at least to an intermediate shape for sealing rings to be formed, and a pressure-forming-medium and associated pressurization means.

In one embodiment, the raised sections of the outer contour of the at least one first roller have radii that are larger than the radii of the raised sections of the outer contour of the at least one second roller, and the device is adapted for producing sealing rings open to the inside. In this case, the first roller can also be designated as contouring roller and the second roller as forming roller.

In an alternative embodiment, the raised sections of the outer contour of the at least one second roller have radii that are larger than the radii of the raised section of the outer contour of the at least one first roller, and the device is adapted for producing sealing rings open to the outside. In this case, the first roller can also be designated as a forming roller and the second roller as a contouring roller.

The forming rollers, i.e., the contouring and forming rollers, can preferably be made of metallic materials such as, for example, tool steel. Alternatively, non-metallic materials, such as ceramics or polymer (composite) materials, are also possible. Rubber rollers or partially rubberized rollers can also be used. Combinations of these materials or different materials for different rollers are also possible such as, for example, a tool steel roller together with a rubberized roller.

In one embodiment, the device has at least two successive steps or forming stations for carrying out the forming process in steps, wherein each step has in each case at least one first roller and at least one second roller, and the outer contour of at least one roller of a respective step is specific for the respective step.

Thus, forming can be configured in a very flexible manner. Possible variants include:
1) The device has a continuous inner roller which is provided section by section with different outer contours corresponding to the respective steps, plus for each step a separate outer roller having in each case its own outer contour (or outer roller, likewise continuous, having different outer contours for each step), wherein the tube is pushed axially forward to the next step, and the step-specific outer roller is then moved toward the tube. This variant can be used, for example, for a quasi-continuous production.
2) The device has a plurality of independent forming steps with an interposed transfer mechanism and in each case separate pairs of rollers.
3) The device has an inner roller and for each step, separate outer rollers are arranged in each case at different places around the tube, which outer rollers are moved for each step in each case successively toward the tube. The advantage of this variant is that no axial feed has to be carried out and the rollers can be arranged in the axial direction in a very compact manner.

This embodiment is equally suitable for single-ring production as well as for the production of a plurality of sealing rings next to one another and at the same time.

In one embodiment, the handling mechanism for removing finished sealing rings can also carry out the transfer of sealing rings or tube pieces between the steps or stations or vice versa.

In one embodiment, the device further comprises a heating device that is adapted for locally or overlappingly heating the tube (2) or portions of the tube (2), wherein the heating device is preferably an induction and/or laser heating device.

The heating device can be provided for supporting the forming process or for carrying out the severing process supported by heat or by melting techniques, for example, by relative movement of the parts to be severed.

### BRIEF DESCRIPTION OF THE DRAWING

FIG. 1 shows different steps of the forming process in a production method according to the invention;

FIG. 2 shows the final shape of different sealing rings which have been produced with a method according to the invention;

FIG. 3 illustrates the different radii of the outer contours of an embodiment of the invention;

FIG. 4 illustrates the directions of rotation of elements of an embodiment of the invention;

FIG. 5 shows schematically a device for carrying out the production method according to the invention;

FIG. 6 shows the arrangement of rollers in an embodiment of the invention; and

FIG. 7 shows the arrangement of rollers in another embodiment of the invention.

### DETAILED DESCRIPTION OF THE INVENTION

Principally, for providing the tubular preliminary product, all known production methods can be used. The two most practicable ones shall be exemplary illustrated here.

In method 1, suitable sheet metal pieces (blanks) are severed from a roll, generally designated as “coil”. The blanks (which can be single-layered or multi-layered) are subjected to a shaping bend-forming or rolling process so that as a result, a tube is created. Subsequently, the tube is also subjected to joining. For this, all positive, non-positive and firmly-bonded connections of combinations thereof can be considered. Preferably, a welding method such as laser welding or plasma welding is used.

After this, a tubular preliminary product is available which has a defined shape, a defined texture (rolling direction), defined diameters (inside and outside), a defined wall thickness (which can vary in different places, however), and a characteristic joint. This means that the characteristic features of the preliminary product can also be found (to a greater or lesser extent) on the later finished product.

In method 2, the sheet metal is unwound from a coil, optionally cut to the right width, and preferably closed in a plurality of steps into a tubular shape. By means of a suitable firmly-bonding, nonpositive-locking or positive-locking method or combinations thereof, the ends are connected to form a closed tube. Preferably, a welding method such as laser welding or plasma welding is used.

After this, a tubular preliminary product is available which has a defined shape, a defined texture (rolling direction), defined diameters (inside and outside), a defined wall thickness (which can vary in different places, however), and a characteristic joint. This means that the characteristic features of the preliminary product can also be found (to a greater or lesser extent) on the later finished product.

It is to be mentioned that besides tubes made of single-layered sheet metal, tubes from a plurality of layers can also be used. For example, a spirally wound tube or a tube made from a “composite metal sheet” such as an aluminum-plated metal sheet or coated metal sheet can also be used.

For producing sealing rings that are made from this tubular preliminary product and have a V-shape, C-shape, S-shape, W-shape or the like in cross-section, a second production process is now required.

According to the present invention, two fundamental production variants and combinations or modifications thereof are possible.

In the case of the production variant 1, first, the entire tube is formed in one production step and is then severed or torn apart into individual rings and is subsequently formed. For this, two contoured rollers are used.

The tube or the preliminary product of defined length is attached onto the at least one first roller and is guided or held with regard to the axial and radial positions. Subsequently, the at least one second contoured roller is moved toward the at least one first roller. Through this movement, the two profile contours of the contoured rollers are pushed into one another, wherein the space between the two contours defines the shape of the later sealing ring.

The tube or its wall is moved in a relative movement between rollers rotating in opposite directions and is thereby subjected to the forming process. It is possible here that in each case only one element of the three involved elements contour roller, tube and forming roller is actively driven or rotated, wherein one or two further elements are passively carried along through friction. In one possible embodiment, for example, the forming roller can be driven, wherein contouring roller and tube are carried along in a freewheeling manner. Principally, the contouring roller can in addition also be driven. It is also possible to drive all three elements.

However, in a further embodiment it is also possible, that the forming device rotates while the tube is kept in position in a rotationally fixed manner. Here, the contouring roller and also the forming roller are driven (in opposite directions) and thus move around the stationary tube. This embodiment is particularly suited, for example, for a kind of “continuous” production in which the quasi-“continuous” tube is only pushed forward, but is not rotated.

In one exemplary embodiment, another criterion of the two contours is that the raised portions (the “wave crests” of the contour) of the outer contour of a roller has larger (curvature) radii than the raised portions of the other roller. Here, the roller having the outer contour with larger radii represents the contouring roller, and the roller having the contour with the smaller radii represents the forming roller.

It is the object of the contouring ring to provide the sealing with a defined contour over which the sealing ring is formed. This means that in the case of a sealing ring open to the inside, the contouring roller outlines the radius facing toward the inside, and in the case of a sealing ring open to the outside, it outlines the radius facing toward the outside.

The object of the forming roller is, on the one hand, to form or roll the sealing ring over the contouring roller in a defined manner and, on the other, to induce at defined places (the small radii of the forming roller) stresses in the tube material that are high enough that the material is overstressed at these places and fails or breaks.

According to an exemplary embodiment, the process is carried out in three steps. First, the tube is preformed and therefore many sealing rings are prerolled next to each other; thereby, the tube is also stiffened or stabilized. By continuously moving the rollers toward each other, the sealing rings are continuously formed until they are severed at the small radii of the forming roller. Finally, the sealing rings which are now available as individual parts are finish formed by moving the rollers further toward each other until the sealing rings have reached their desired final contour. The steps of this process thus include initial preforming, severing and final finish forming.

In an exemplary production variant 2, starting from one end or optionally from both ends, the tube is first preformed, then severed or torn off, and finally finish formed in continuously successive production steps—sealing ring for sealing ring. For this, two (or more, if necessary) contoured rollers are used. The basic production sequence, the initial preforming, the severing and the final finish forming can be maintained here. However, as an alternative, it is also possible to first completely finish form the ring and to sever it only at the very end.

The production process according to the invention can result in a tapering of the sealing ring ends which is visible on the final product. Furthermore, this production results in a characteristic separation or fracture edge. Unless the sealing ring is subject to a subsequent heat treatment, the separation or fracture edge is also visible on the final product.

If said tapering is not desired, the tube has to be “compressed” during the production process. The production plant has then to provide or consider the possibility of compacting or compressing the tube in the axial direction. The above-described high-pressure forming method and the rubber forming method are particularly suitable for enabling a forming process without reducing the wall thickness at the ends.

The method according to the invention can also be carried out in variants or modifications or in partial steps. This is described in the two following examples.

### EXAMPLE 1

If material for the sealing ring is to be used that has a high elasticity, then it is possible that the process step of severing is not sufficient for separating the tube in one pass into individual sealing rings. In this case, an additional production step has to be integrated in which a cutting roll with an adapted pitch and with very small, i.e., sharp radii is used. In this manner, the tube is predamaged or precut prior to forming so that the forming roller can sever or separate the sealing rings during the actual production process.

As an alternative to this, a complete cutting-off is also possible, which can be carried out prior to or after the forming process.

### EXAMPLE 2

It is also possible to separate the tube first into straight or smooth rings and to subsequently finish roll these individual rings in a single-ring production, or to use an above-described roller system in which many individual rings are rolled or formed simultaneously. A side effect of this approach is that the edges of the sealing rings than have a typical cut-off or pinch-off edge (similar to the fracture edge); however, the sealing ring maintains a homogenous material thickness (unless different material thicknesses are rolled during the forming process).

Alternatively, it is also conceivable to inductively heat the tube at defined places so as to support the severing process or to facilitate the forming of the final contour. In locally very confined areas (which extend annularly around the tube) it is also conceivable to intensely heat the tube to such an extent that with very low cutting force or even only with a relative movement between tube and sealing ring or between a plurality of sealing rings, these rings can be severed from one another. The latter method would result in a very distinctive shearing edge (unless the material is subjected to an intense heat treatment) which is probably visible on the later product. This severing process can be integrated in the overall production process or can be carried out as a separate process.

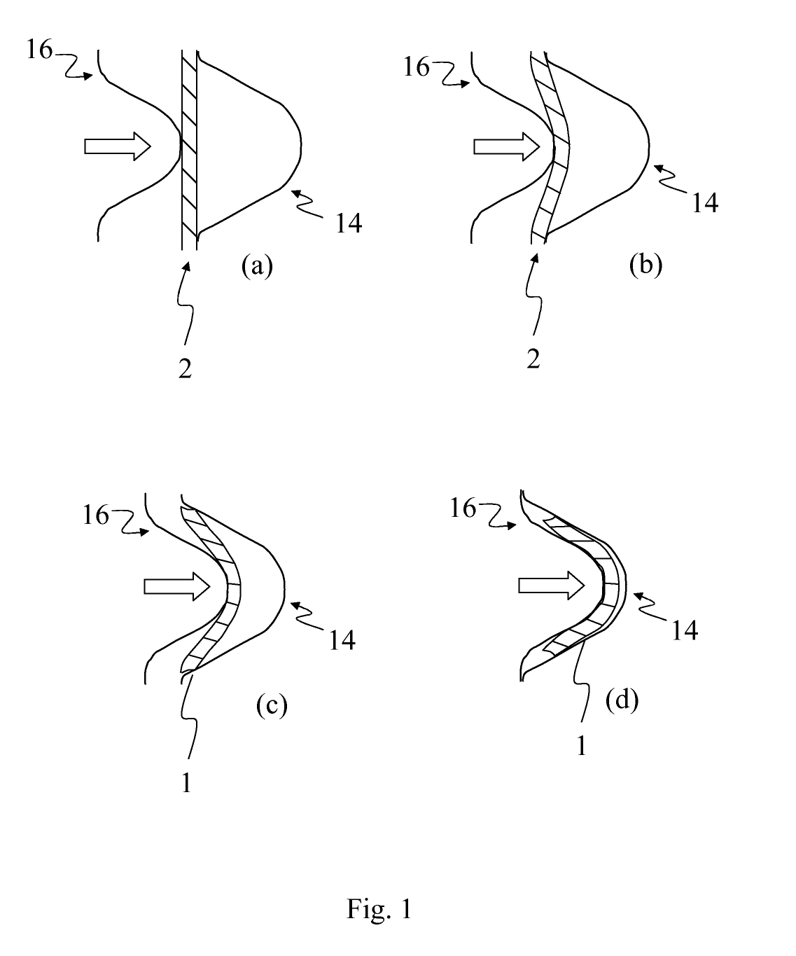

FIG. 1 shows different steps of a method according to the invention. Here, the tube 2 or the sealing ring 1 is in each case shown in cross-section. Of the respective contours of the contouring roller (in each case on the left in the Figure) and the forming roller (in each case on the right in the Figure), in each case only the contour corresponding to a sealing ring is shown.

In step (a), a tubular preliminary product 2 is arranged and held between the contour 16 of a contouring roller and the contour 14 of a forming roller. The forming roller is moved toward the contouring roller. Prior to the contact of the contour 16 with the tube 2, no deformation has been taken place yet.

In step (b), the profile of the sealing ring to be formed is preformed in the tube 2 through a continued movement of the forming roller toward the contouring roller. In this step, the tube 2 is still one piece.

Step (c) shows the situation in which the sealing ring 1 has been severed by continuously deforming the tube 2. By overloading the material at the small radii of the forming roller, the sealing ring has been torn off or broken off.

In step (d), the sealing ring has adopted its final shape through finish forming. By having moved the forming roller as close as possible to the contouring roller, the sealing ring was given its shape through the remaining space between the contour 14 of the forming roller and the contour 16 of the contouring roller. It is to be noted that usually the ring shape will not be exactly the same as the remaining space between the contours, but the sealing ring will slightly relax again at the latest after opening the rollers (material-dependent and contour-dependent springback behavior).

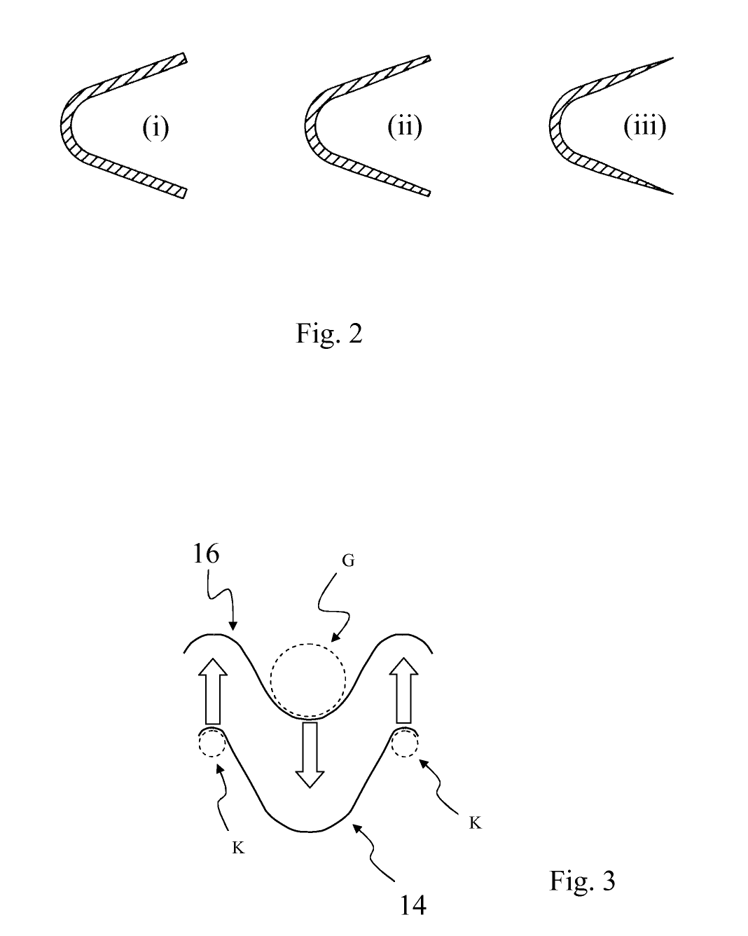

FIG. 2 shows cross-sections of the different geometries of sealing rings produced according to the invention. At (i), a sealing ring with a V-shape and a constant material thickness is shown. Such sealing rings can be produced, for example, with a method as explained in the above-described example 2.

At (ii) and (iii), sealing rings are shown which likewise have a V-shape and which are tapered to varying degrees toward the sealing surfaces. This property can be desirable since due to the tapering, the internal stresses are uniformly distributed over the entire cross-section which is beneficial for the resilient behavior and the fatigue properties or fatigue strength properties. Moreover, it can be set in this manner how large the sealing edge has to be and therefore how high the sealing force or line load will be.

Depending on the selection of the contours of forming and contouring rollers in combination with the sealing ring material to be used, these sealing rings can be generated with tapered sealing surfaces. In particular in embodiments in which severing takes place by means of controlled overload acting on the material during the forming process, these taperings can occur due to the tension induced in the direction of the material before cracking or breaking takes place as a result of material failure.

FIG. 3 serves for clarifying the arrangement of the radii of the respective outer contours. The moving direction of the rollers during the forming process is indicated with arrows, wherein the tube is not shown here for the sake of clarity. On the upper roller having the outer contour 16, the radii of the raised portions (i.e., of the portions which protrude the farthest or which are the first to come in contact with the tube wall) are large, as indicated with the dashed circle G. Thus, according to the foregoing, the upper roller is the contouring roller. In contrast, on the lower roller having the outer contour 14, the radii of the raised portions are smaller, as indicated with the dashed circles. Thus, in the illustrated case, this roller is the forming roller.

The classification into “contouring roller” and “forming roller” depends on the conditions of the large or small radii and not whether it is the respective inner or outer roller. Since the situation here is shown only in cross-section, the type of the sealing ring (thus, open to the inside or open to the outside) that can be produced with the rollers depends on which roller is on the inside and which roller is on the outside.

If the upper roller having the outer contour 16 is the inner roller, a sealing ring open to the inside can be produced therewith. In the other case, if the roller having the outer contour 14 is the inner roller, a sealing ring open to the outside can be produced.

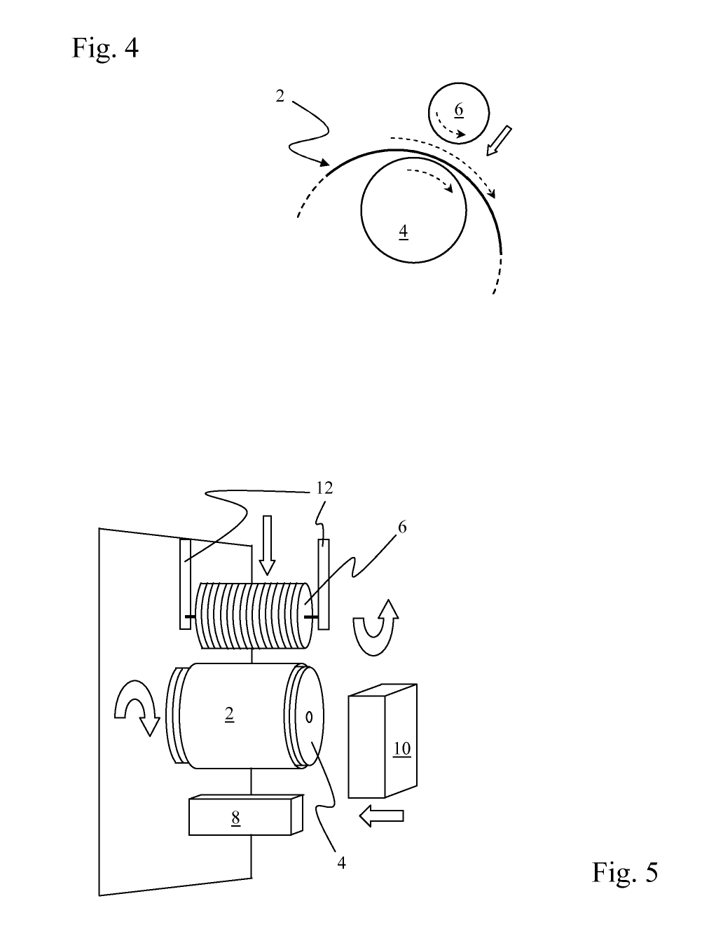

FIG. 4 shows a possible combination of the directions of rotation of the involved elements tube 2, inner roller 4 and outer roller 6. In this embodiment, the tube 2 can be freewheeling, thus is not actively driven. If the inner roller 4 is driven in clockwise direction and the outer roller 6 is moved in the direction indicated with an arrow toward the roller 4 and the tube 2, the tube 2 is also rotated in the clockwise direction. Here, the roller 6 does not have to be driven, but it can rotate (counterclockwise). However, it can also be actively driven.

Other combinations of driven and merely freewheeling elements are possible. For example, it is conceivable to design the rollers 4 and 6 as freewheeling rollers and to rotate only the tube 3. With increasing clamping support of the tube wall between the rollers 4, 6, said rollers will then finally rotate in the shown directions of rotation.

FIG. 5 exemplary and schematically shows a device for carrying out the method according to the invention. A tubular preliminary product 2 is arranged on a contouring roller 4. For this purpose, a feeding mechanism 8 is provided which, for example, by moving toward the tube and advancing said tube under frictional traction, enables the transport.

A forming roller 6 can be moved toward the contouring roller 4 by a drive 12. The tube can be set in rotation in a first direction of rotation (left arrow) by a non-illustrated drive mechanism. The forming roller 6 can rotate through friction while being pushed onto the tube 2, or it can be set in rotation in an opposite rotational direction (right arrow) by a likewise non-illustrated drive mechanism in order to keep the friction to the tube 2 low.

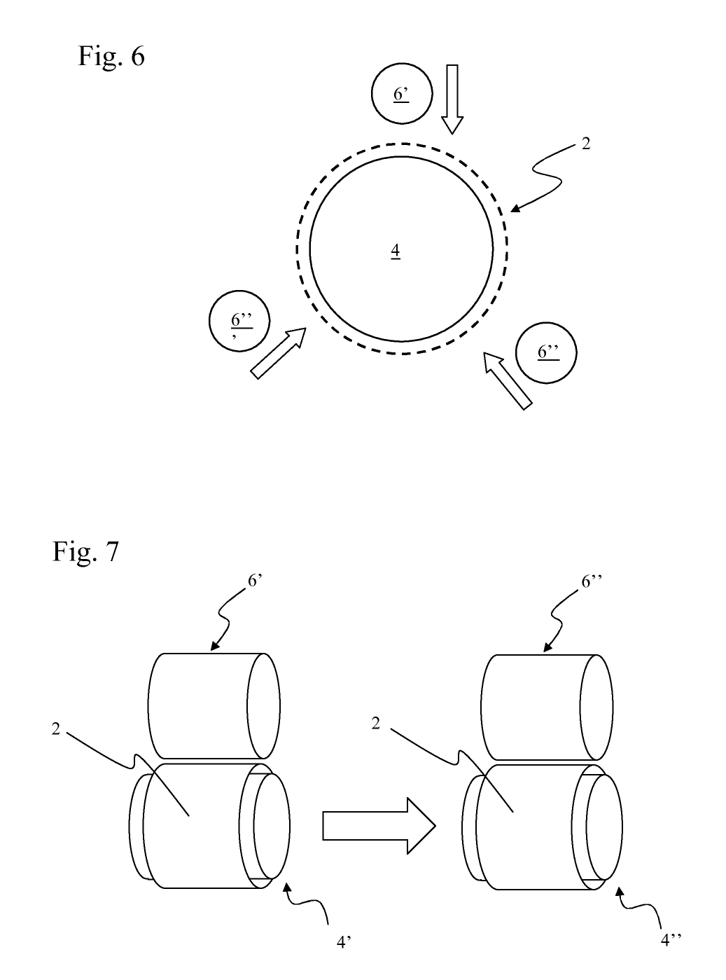

FIG. 6 shows an embodiment of the invention in which the forming process of the sealing rings is carried out in a plurality of steps (here, three steps). For this, an inner roller 4 having a uniform outer contour is provided, onto which a tube 2 (dashed line) is slid. In the first step of forming, a first outer roller 6′ is moved toward the roller 4, and an intermediate shape of the sealing ring or sealing rings to be formed is formed as described above by relative movement of the tube wall between the rollers 4, 6′. In the next step, a further intermediate shape is then formed between the second outer roller 6″ and the inner roller 4.

In the shown embodiment, finally, the shape of the sealing ring is generated between the third outer roller 6′″ and the roller 4. In an alternative embodiment, finish forming could take place between roller 6″ and roller 4, wherein roller 6″ is configured as a cutting roll. As a further alternative, the roller 6′ could be designed as a cutting roll for cutting sealing rings, wherein the sealing ring or the sealing rings is formed and severed by the further rollers 6″ and 6′″. The advantage of this embodiment is that between the individual processing steps, no transfer of the processed tube piece is required.

FIG. 7 shows an embodiment of the invention in which the forming process of the sealing rings is carried out in two steps. In the first step, the tube 2 is preformed between the rollers 4′ and 6′. After this, the tube piece is transferred to the second step, for example, by a feed in the axial direction. The sealing ring is then given the final shape between the further rollers 4″ and 6″.

In an alternative embodiment, rather than being a separate roller, each of the inner and outer rollers can also be designed as a partial contour on a quasi-continuous roller. This variant is suitable, for example, for a quasi-continuous production because in this variant, the tube has only to be advanced axially by one step, wherein all steps can operate in parallel in different stages of work.

1. A method for producing sealing rings open to the inside or open to the outside, comprising
providing a tube of sealing ring material,
arranging the wall of the tube between at least one first roller that is parallel to the tube and has a first outer contour, and at least one second roller that is parallel to the tube and has a second outer contour;
carrying out a relative movement of the at least one first roller and the at least one second roller toward each other;
forming at least one sealing ring by a relative movement of the wall of the tube between the at least one first roller and the at least one second roller, wherein the cross-section of the at least one sealing ring is defined substantially by the space between the first and the second outer contours; and
severing the at least one sealing ring from the tube.

2. The method according to claim 1, wherein at least during forming
the at least one first roller rotates in a first direction of rotation; and/or
the at least one second roller rotates in a second direction of rotation; and/or
the tube rotates in the first direction of rotation.

3. The method according to claim 1, wherein in each case one sealing ring after the other is produced, or a plurality of sealing rings is produced at the same time.

4. The method according to claim 1, wherein severing takes place during forming.

5. The method according to claim 4, wherein forming comprises an initial preforming and a final finish forming, and severing takes place between preforming and finish forming.

6. The method according to claim 1, further comprising
at least cutting the wall of the tube with a cutting roll that is parallel to the at least one first roller;
wherein by said cutting the positions are determined at which severing the at least one sealing ring is to be carried out, or at which the at least one sealing ring is severed by completely cutting it off.

7. The method according to claim 1, wherein during forming, the wall thickness of the at least one sealing ring
is increased or reduced at predeterminable positions; or
is maintained substantially homogenous.

8. The method according to claim 1, further comprising axially compressing the tube.

9. The method according to claim 1, wherein forming is carried out in at least two successive steps, wherein per step at least one first roller and at least one second roller are involved in the forming process, and the outer contour of at least one involved roller is specific for the respective step.

10. The method according to claim 1, further comprising heating the tube at defined places.

11. A device for producing sealing rings open to the outside or to the inside, comprising
at least one first roller having a first outer contour;
at least one second roller that is parallel to the first roller and has a second outer contour;
a feeding mechanism adapted for arranging the wall of a circular cylindrical tube between the at least one first roller and the at least second roller;
at least one drive mechanism that is adapted for rotating the tube and/or the at least one first roller in a first direction of rotation, and/or for rotating the at least one second roller in a second direction of rotation;
a movement mechanism that is adapted for carrying out a relative movement of the at least one first roller and the at least one second roller toward each other so as to form at least one sealing ring by a relative movement of the wall of the tube between the at least one first roller and the at least one second roller, wherein the cross-section of the at least one sealing ring is defined substantially by the space between the first and the second outer contours; and
a severing mechanism that is adapted for severing the at least one sealing ring from the tube.

12. The device according to claim 11, further comprising a handling mechanism for removing finished sealing rings.

13. The device according to claim 11, wherein the outer contours of the at least one first roller and the at least one second roller correspond to a plurality of sealing rings, and wherein the device is adapted for producing a plurality of sealing rings at the same time.

14. The device according to claim 11, further comprising
at least one cutting roll that is parallel to the at least one first roller;
a second movement mechanism that is adapted for carrying out a relative movement between the at least one cutting roll and the at least one first roller toward each other so as to cut the wall of the tube by means of the cutting roll so that the places are determined at which severing the at least one sealing ring is to be carried out, or for completely cutting off the wall of the tube so that the at least one sealing ring is severed.

15. The device according to claim 11, wherein the outer contour of the at least one first roller and/or the at least one second roller are adapted for
tapering or thickening the at least one sealing ring at predeterminable places during forming; or
for keeping the wall thickness of the at least one sealing ring substantially homogenous during forming.

16. The device according to claim 11, further comprising a compressing mechanism that is adapted for compressing the tube in the axial direction, wherein the compressing mechanism is preferably a hydroforming device and/or a rubber forming device.

17. The device according to claim 11, wherein
the raised sections of the outer contour of the at least one first roller have radii that are larger than the radii of the raised sections of the outer contour of the at least one second roller, and the device is adapted for producing sealing rings open to the inside; or
the raised sections of the outer contour of the at least one second roller have radii that are larger than the radii of the raised section of the outer contour of the at least one first roller, and the device is adapted for producing sealing rings open to the outside.

18. The device according to claim 11, wherein the device has at least two successive steps for carrying out the forming process in steps, wherein each step has in each case at least one first roller and at least one second roller, and the outer contour of at least one roller of a respective step is specific for the respective step.

19. The device according to claim 11, further comprising a heating device that is adapted for locally or overlappingly heating the tube or portions of the tube, wherein the heating device is preferably an induction and/or laser heating device.

20. A sealing ring open to the inside or to the outside, produced by means of a method according to claim 1.
